(19) United States
(12) Patent Application Publication
(10) Pub. No.: US 2003/0211448 A1
(43) Pub. Date: Nov. 13, 2003

(54) 3-dimensional apparatus for self-paced integrated procedure training and method of using same

(75) Inventors: Remi Quimper, Montreal (CA); Michele Asmar, Dollard-des-Ormeaux (CA); Luc Ethier, Laval (CA)

Correspondence Address: OGILVY RENAULT, 1981 MCGILL COLLEGE AVENUE, SUITE 1600, MONTREAL, QC, H3A2Y3, CA

(73) Assignee: CAE Inc., Saint Laurent (CA)

(21) Appl. No.: 10/139,816

(22) Filed: May 7, 2002

(51) Int. Cl. G09B 19/00

(52) U.S. Cl. 434/219

(57) ABSTRACT

An integrated procedure training apparatus provides a three-dimensional environment that facilitates the training of systems and integrated procedures required to operate and maintain complex systems. The three-dimensional environment is created by arranging a plurality of touch-sensitive display surfaces in a spatial arrangement that is similar to a spatial arrangement of real control panels of the complex system. The training of the integrated procedures is enabled by the use of a full-scope simulation of the complex system. Courseware or other training aids can be used in conjunction with the system to improve learning absorption and retention and reduce training time and reliance on skilled instructors.

### CROSS-REFERENCE TO RELATED APPLICATIONS

This is the first application filed for the present invention.

### MICROFICHE APPENDIX

Not Applicable.

### TECHNICAL FIELD

The invention relates to computerized systems for integrated procedure training and, in particular, to an arrangement of touch-sensitive display surfaces for simulating a control station of a complex system, in order to provide students with a tool for self-paced learning or practicing integrated procedures required to operate or maintain the complex system.

### BACKGROUND OF THE INVENTION

The training of operations, control and maintenance personnel for complex systems, like commercial jet airliners, nuclear power plants, chemical processing plants, etc., represents a substantial cost to the related sector. Extensive training is required to qualify the personnel for respective procedures on each platform on which the personnel will operate. A significant part of the training is dedicated to learning systems and integrated procedures for operating and maintaining the complex system.

It is well known in the art that performing integrated procedures safely requires in-depth knowledge of how sub-systems of the complex system interact. Consequently, integrated procedure training teaches personnel about the interactions of the sub-systems, in relation to particular procedures and operations. Personnel generally have to be competent to perform a wide variety of procedures in support of predefined objectives, like operating, controlling, modifying, verifying, updating, troubleshooting, maintaining or recording a state of the complex system.

Because it is critical to properly train and test complex system personnel prior to allowing them to perform operations (especially integrated procedures) on live complex systems, and because trained personnel may need refresher or remedial programs, there is significant demand for live complex system simulation-based training. This demand is further extended by a duration of the required training. A number and complexity of procedures the personnel may need to learn, and the intricate interrelation of sub-systems and components implicated in these procedures, have frequently led to protracted, integrated procedure training that involves a number of stages.

As is well known in the art, a condition of a complex system is generally monitored and controlled at one or more control/maintenance stations. Each of the control/maintenance stations usually includes a plurality of components having respective control panels that display state information, and provide an interface for issuing commands governing one or more aspects of the complex system. Most often each of the control panels has numerous switches, buttons, dials, keypads etc. for entering the control commands, along with multiple display elements. Learning integrated procedures therefore involves not only learning a correct sequence of control commands needed to effect the procedure, what to do in the event of an error, at which points in the procedure displays should be consulted, etc., but also physical motions needed to effect control, read the displays, etc. Learning the procedures as a disembodied sequence of actions makes it difficult for the trainee to obtain an understanding of how the subsystems interact with each other, to successfully evaluate a situation or an event and apply the appropriate actions, particularly with speed and efficiency when posted at a real control/maintenance station.

Accordingly, in most sectors where integrated procedure training for a complex system is required, 3-dimensional training stations that faithfully reproduce the spatial arrangements and behavior of the control panels at the control/maintenance station are used to imbed a student in the milieu of the complex system, to permit the student to visualize and experience events in the large complex system, and to practice the physical motion component of the procedures as well as to obtain an orientation in space of where all the panels and displays are located. Normally, the 3-dimensional training station is a faithful reproduction of the real control/maintenance station. Such 3-dimensional training stations are expensive to construct, and can only be used for procedure training and evaluation on the particular complex system that they were constructed to imitate. Furthermore, most of the 3-dimensional training stations do not accurately reproduce conditions or behaviors of the complex system they imitate. While some are equipped with limited function emulators, those are usually programmed using a “scripted response” technique well known in the art. Scripted responses do not provide realistic feedback when performing integrated procedures, because important subsystem interaction is inadequately simulated.

There therefore exists a need for a 3-dimensional training apparatus to provide a virtual station that permits the students to learn or practice both the mental and physical components of integrated procedures, at the same time.

### SUMMARY OF THE INVENTION

It is therefore an object of the invention to provide an apparatus for training students to learn system knowledge and perform integrated procedures on complex systems using a plurality of control panels that are spatially arranged to simulate control panels of a complex system.

Another object of the invention is to provide an apparatus for permitting self-paced system knowledge and integrated procedure training for complex systems using self-paced courseware.

Accordingly an apparatus for training a student to perform an integrated procedure on a complex system using a plurality of control panels is provided. The apparatus features a set of touch-sensitive display surfaces that are arranged so that representations of the control panels displayed on the touch-sensitive display surfaces are spatially arranged to mimic the control panels of the complex system. The touch-sensitive display surfaces are adapted to communicate with a processor each time a student makes an input from the touch sensitive display surfaces, and the result of the student inputs is forwarded to the full-scope simulation of the complex system. The full-scope simulation uses the result of the student input to update its state. This change in state is used to dynamically update the interactive graphic representations of the control panels.

The touch-sensitive display surfaces are preferably touch screens, that are supported in their spatial arrangement by a support structure having a plurality of display support points for captively holding the touch-sensitive display surfaces. The support points are preferably adapted to be reoriented and repositioned so that the touch-sensitive display surfaces can be arranged in more than one configuration. The apparatus can therefore be used for training integrated procedures for control stations of a set of complex systems, and can therefore be rearranged to adapt to changes in the control panels used in the complex systems. Anyone one supporting member of the support structure can be adapted to be reconfigured, in order to change relative positions of the touch-sensitive display surfaces, so that the touch-sensitive display surfaces can be arranged as control panels of different complex systems.

The invention also provides a method for providing self-paced courseware on systems and integrated procedure training apparatus so that a student can learn the skills and knowledge related to the complex system. In accordance with the method, a plurality of touch-sensitive display surfaces are arranged on a 3-dimensional support structure of the integrated procedure training apparatus in a spatial arrangement that is similar to a spatial arrangement of control panels of the complex system, and then the full-scope simulation server that runs a simulation of the complex system in response to user inputs sensed by the touch-sensitive display surfaces, effects the display of interactive graphic representations of the control panels on the touch-sensitive display surfaces.

Advantageously, an image displayed on the touch screens is controlled by software, and so each touch screen can be configured to display different components, having respective different interfaces, for different complex systems. This capability makes the apparatus a versatile training station. Further the low cost of the touch screens and standard communications and computing devices, permit the data provided by the very expensive full-scope simulation server to be accessed from substantially anywhere via a network. A remote or local instructor can access conditions of a simulated complex system to monitor the training of the student, in free-play or with the advantageous use of self-paced courseware.

### BRIEF DESCRIPTION OF THE DRAWINGS

Further features and advantages of the present invention will become apparent from the following detailed description, taken in combination with the appended drawings, in which:

FIG. 1 is a schematic diagram illustrating an integrated procedure training apparatus in accordance with an embodiment of the invention;

FIG. 2 is a schematic diagram illustrating another embodiment of the apparatus shown in FIG. 1 featuring articulated joints that make the apparatus configurable;

FIG. 3 is a schematic diagram illustrating another embodiment of an apparatus in accordance with the invention;

FIG. 4 is a schematic diagram illustrating a computer system for providing real-time graphical simulation information to an apparatus in accordance with an embodiment of the present invention;

FIG. 5 is a schematic diagram illustrating a variation of the computer system for remote delivery of the training procedure illustrated in FIG. 4; and

FIG. 6 is a schematic diagram illustrating a computer system for delivering the training without courseware.

It should be noted that throughout the appended drawings, like features are identified by like reference numerals.

### DETAILED DESCRIPTION OF THE PREFERRED EMBODIMENT

The present invention provides a method and apparatus that permits complex system control, operations, and maintenance personnel to be trained, or to practice, integrated procedures required to control, operate or maintain the complex system. The apparatus includes spatially arranged touch-sensitive display surfaces that display at least parts of interactive graphic representations of control panels of the complex system, and one or more computing machines for exchanging data between the touch-sensitive display surfaces and a full-scope simulation server. In accordance with the method, operator and maintenance personnel are trained to perform integrated procedures in a three-dimensional environment that closely mimics the spatial arrangement of the real control panels of the complex system thus permitting the personnel to acquire “muscle memory” associated with the movements and mental models developed by performing the integrated procedures.

One example of a control/maintenance station that can be simulated by an apparatus in accordance with the invention is a cockpit of an aircraft. Both ground crew and flight crew must learn systems, perform integrated procedures to test aircraft systems; perform routine maintenance operations, inspections, and modifications; and, practice in-flight emergency as well as standard operating procedures, etc. as is well known in the art.

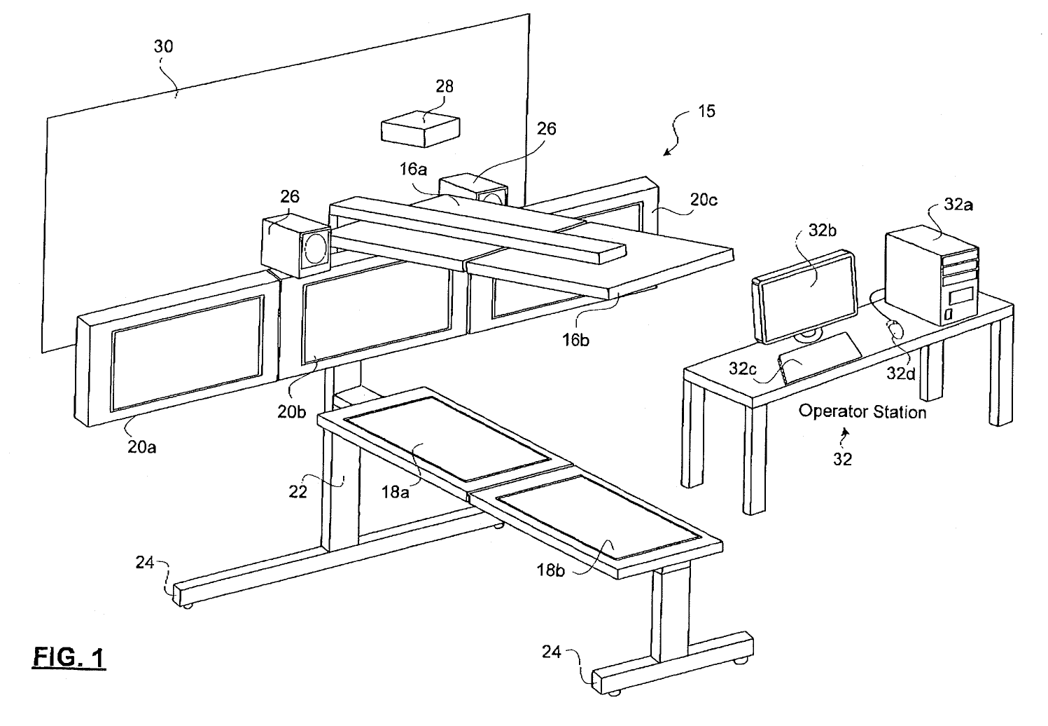

FIG. 1 is a schematic diagram illustrating an integrated procedure training apparatus 15 in accordance with one embodiment of the invention. The integrated procedure apparatus 15 is configured to serve as a cockpit training apparatus. Consequently, it includes two touch-sensitive display surfaces 16a, 16b of an overhead of a cockpit, two touch-sensitive display surfaces 18a, 18b representative of a pedestal of a cockpit, and three touch-sensitive display surfaces 20a, 20b and 20c representative of a main instrument panel of the cockpit. The touch-sensitive display surfaces may be, for example, touch-sensitive liquid crystal displays (LCDs), or rear projection screens having a display surface covered with a touch-sensitive element of a type well known in the art. The integrated procedure training apparatus 15 preferably further includes at least one speaker 26 that may be used for simulated audible warnings generated by the full scope simulation of the complex systems, to narrate courseware instruction to facilitate integrated procedure training, or to permit an instructor to provide verbal instructions to one or more students operating the integrated procedure apparatus, or the like. The integrated procedure training apparatus 15 preferably further includes an associated projector 28 that is used to project visual images on a projection screen or backing wall 30. The projector 28 and the screen 30 are used, for example, to display system schematics, to display courseware text or instructions, or display text providing suggestions for remedial action if a student has incorrectly performed a procedure, or to display any other multi-media material used for training. Alternatively, or in addition, the projector may be used to display environment, in a case where the integrated procedure training apparatus is configured for flight crew training, or any other mobile system. For example, the projector 28 may be used to project visual images that simulate flight, or traversed terrain, or the like, as appropriate to the system being simulated.

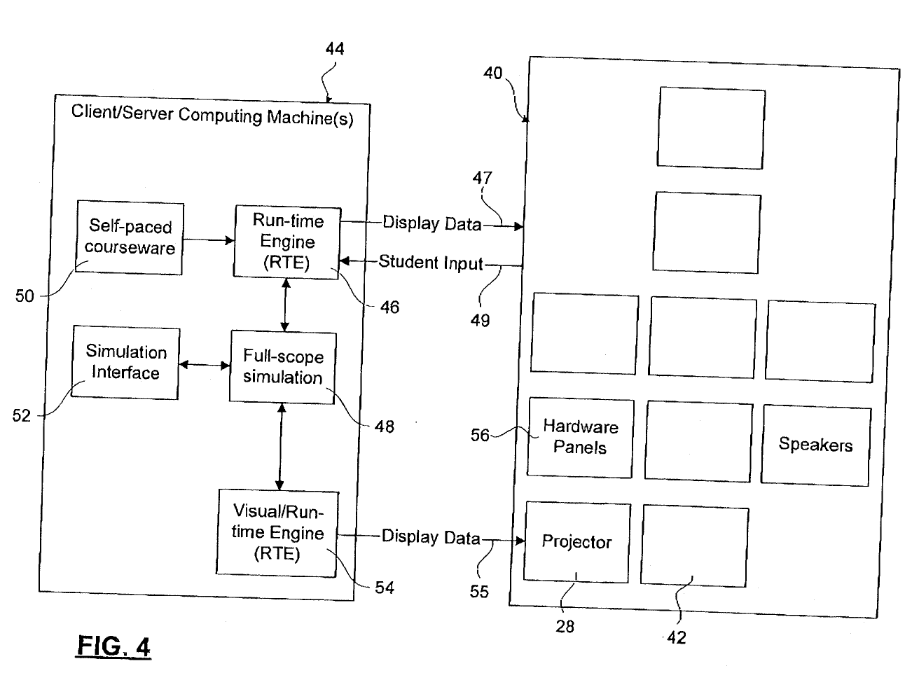

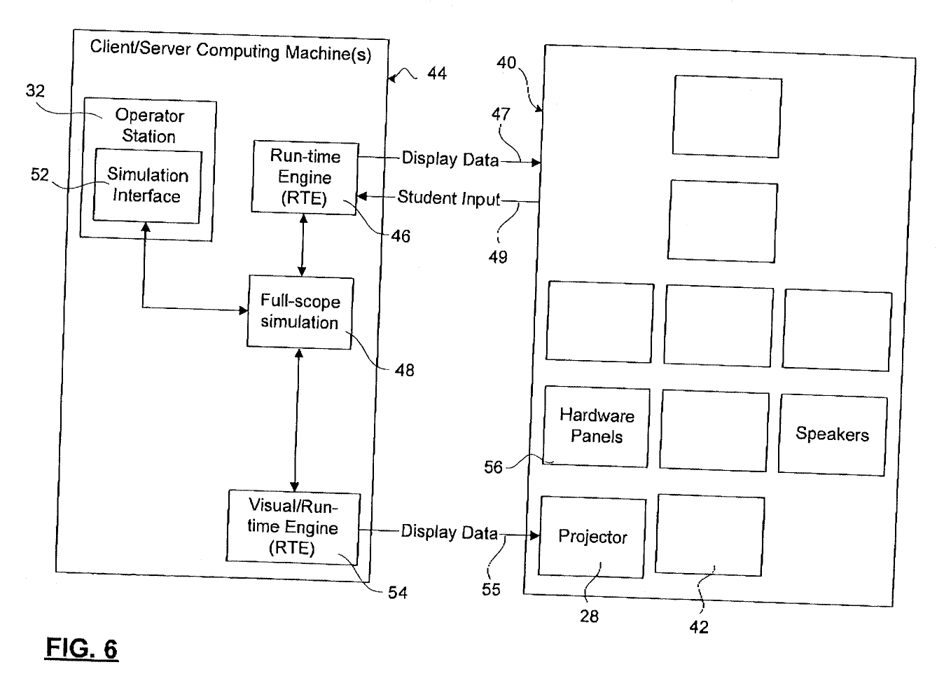

The procedure training apparatus further includes an operator station 32 which may be used by a student or an instructor to input control data to a full-scope simulation that runs in conjunction with the integrated procedure training apparatus 15, or to select a course if the apparatus 15 is being operated in a courseware mode. The operator station 32 includes, for example, a desktop computing system 32a that supports a display screen 32b, a keyboard 32c and a pointing device such as a mouse 32d. The operator station will be explained below in more detail with reference to FIGS. 4 and 6.

As will be understood by those skilled in the art, the operator station may also be used, rather than projector 28 and the projection screen 30, to display information related to courseware, and the like, while a student is training at the integrated procedure apparatus 15. The control data entered using the operator station 32 is used to condition a full-scope simulation used during training. The control data is used, for example to specify fuel load, operating conditions, and other variables used to condition the full-scope simulation to simulate conditions in which the training or practice are to be effected.

The integrated procedure training apparatus 15 can be further enhanced by adding other 3-dimensional elements, such as the hardware equivalent of the sub-systems of the complex system. For example, the integrated procedure training apparatus 15 may be enhanced by the addition of an auto-pilot control panel, a flight management system (FMS) control display unit (CDU), throttles and other control panels, so that tactile feedback and mental models are acquired during integrated procedure learning and practice.

A structure 22 of the integrated procedure training apparatus 15 supports the touch-sensitive display surfaces 16a-20c in their spatial arrangement. The structure 22 includes two base members 24 that support the apparatus and display support points (not shown) to which the touch-sensitive display surfaces are affixed. The structure 22 rigidly supports the touch-sensitive display surfaces against forces that may be applied by the student while the apparatus 15 is in use. The purpose of the integrated procedure training apparatus 15 configured as shown in FIG. 1 is to provide systems and integrated procedure training for maintenance and flight crews. Such training may be monitored or evaluated by an instructor. It may also be performed in any number of controlled training or practice modes using the same automated courseware, as described in Applicant's co-pending United States patent application entitled METHOD AND APPARATUS FOR SELF-PACED INTEGRATED PROCEDURE TRAINING USING A REAL-TIME, FULL-SCOPE SIMULATION, the specification of which is incorporated herein by reference. The integrated procedure training apparatus 15 may also be used in a non-monitored, non-guided (free-play) mode. In the free-play mode, the student uses the operator station 32 to input simulation condition to configure the full-scope simulation in a condition desired for practice, as described above.

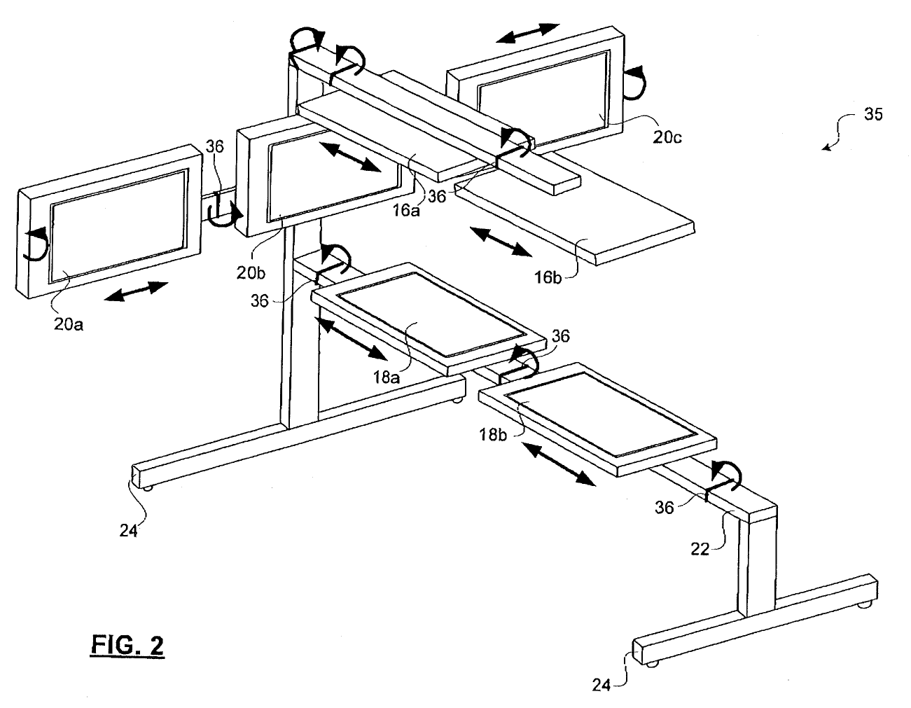

FIG. 2 is a schematic diagram of another embodiment of the integrated procedure training apparatus in accordance with the invention. In this embodiment, the support structure 22 includes one or more articulated joints 36 to permit the integrated procedure training apparatus 35 to be reconfigured to imitate spatial relations of control panels in various aircraft, or other complex systems. While articulated joints 36 are illustrated between each of the respective touch-sensitive display surfaces, it should be understood that the integrated procedure training apparatus 35 shown in FIG. 2 may include more, or fewer, articulated joints. For cockpit simulators, articulated joints on the overhead display surfaces 16a, 16b and between the pedestal display surfaces 18a, 18b are most practical as they permit the pedestal and overhead display surfaces to be configured in landscape or portrait configurations to more closely replicate the spatial arrangement of control surfaces in various aircrafts. The respective display surfaces 16a,to 20c may likewise be supported by slidable mounts (not shown) to permit the respective display surfaces to be moved longitudinally in either direction along the support structure 22 to facilitate reconfiguration.

Advantageously, therefore, the same integrated procedure training apparatus 35 can be modified to enable personnel to learn integrated procedures on different complex systems. Integrated procedures, as noted above, are procedures that provide a student with knowledge about the complex interrelations between sub-systems of a complex system, because the procedures involve or affect many of the sub-systems. Integrated procedures involve interactions with spatially arranged control and display equipment in a 3-dimensional environment that mimics the control/maintenance station of the complex system. Training motor reflexes is an important part of learning integrated procedures, along with building a mental model of each sub-system's behavior and their interrelations. While touch-sensitive display surfaces may not provide realistic tactile representations of some complex system controls, the students who use apparatus 15, 35 in accordance with the invention learn where to look, move and reach for the required controls and/or information, and in which direction and sequence body movements must be made in order to perform any given integrated procedure.

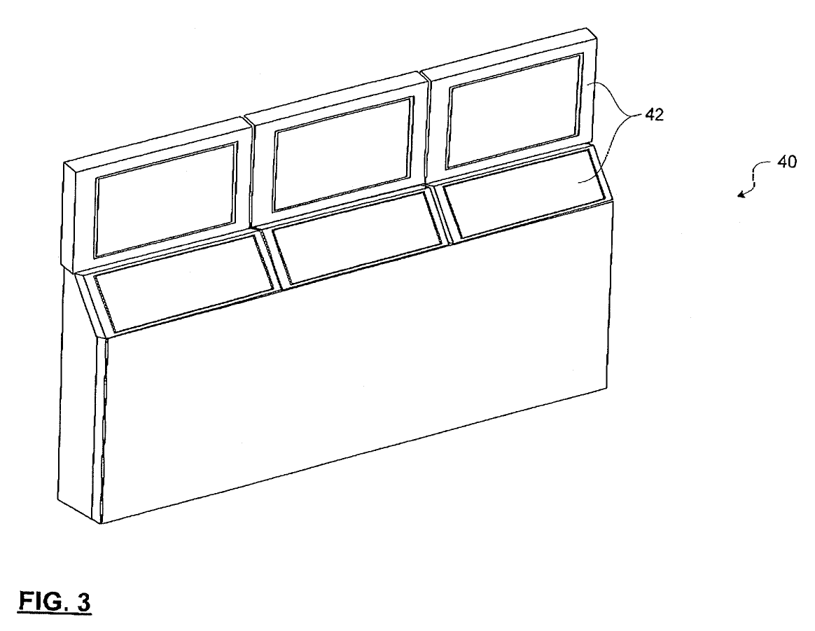

FIG. 3 is a schematic diagram of another embodiment of the invention. In this embodiment, an integrated procedure training apparatus 40 includes a plurality of touch-sensitive display surfaces 42, arranged to simulate a three-dimensional control station of a complex system, such as a nuclear power plant, marine control system, or the like. The control station of the simulated complex system are displayed on the display surfaces using interactive graphic representations of the switches, dials, control levers, gauges, and other instruments and information displays that are present on the real control panels in as near to photo-realistic effect as possible. Consequently, operator and maintenance personnel can learn or practice integrated procedures using the training apparatus 40, and acquire the muscle memory and mental models developed by moving around the control station simulated by the apparatus 40. As will be understood by those skilled in the art, although the integrated procedure training apparatus 40 is a relatively simple implementation of the invention, the availability of multi-processor computing, and parallel computing systems using networked computing machines makes it practical to develop a verv large integrated procedure training apparatus that can be arranged in a three-dimensional space to simulate a control room of a nuclear power plant, or any other very large complex system that can be simulated.

FIG. 4 is a schematic diagram of an integrated procedure training apparatus 40 in accordance with the invention, and client/server computing machines 44 for driving the touch-sensitive display surfaces 42 to display the interactive graphic representations of control panels of a simulated complex system. In this embodiment, the simulated complex system is a cockpit of an aircraft. Consequently, aside from the touch-sensitive display surfaces 42, the integrated procedure training apparatus further includes the projector 28, as described above with reference to FIG. 1, and additional hardware 56, including a control display unit (CDU) which is a component of modern aircraft that is used by the flight and maintenance crew to input control data such as a flight plan, etc. The additional hardware 56 further includes a autopilot control panel, that is used to control automatic flight. These components are hardware simulations of the real devices to provide tactile feedback with the training and practice experiences.

The integrated procedure training apparatus 40 is connected to the client/server computing machines in a manner well known in the art. Bi-directional communications connections permit display data 47 to be sent from a run-time engine (RTE) for controlling the interactive graphic representations of the simulated control panels, and courseware information displayed by the projection system, permit the touch-sensitive display surfaces 42 to return student inputs sensed by the touch-sensitive elements associated with the respective display surfaces 42. The student inputs may likewise be generated by inputs to the additional hardware 56, as described above. As explained in Applicant's co-pending patent application referenced above, the RTE 46 receives the display data from the full-scope simulation 48. The RTE may also receive display data from self-paced courseware 50, which may generate information text or instructions that is displayed over a portion of the simulated control panels or on the projection screen 30.

In addition the projector 28 can provide a visual scene to enhance the integrated procedure training apparatus. This is done by synchronizing the full scope simulation status with the visual database.

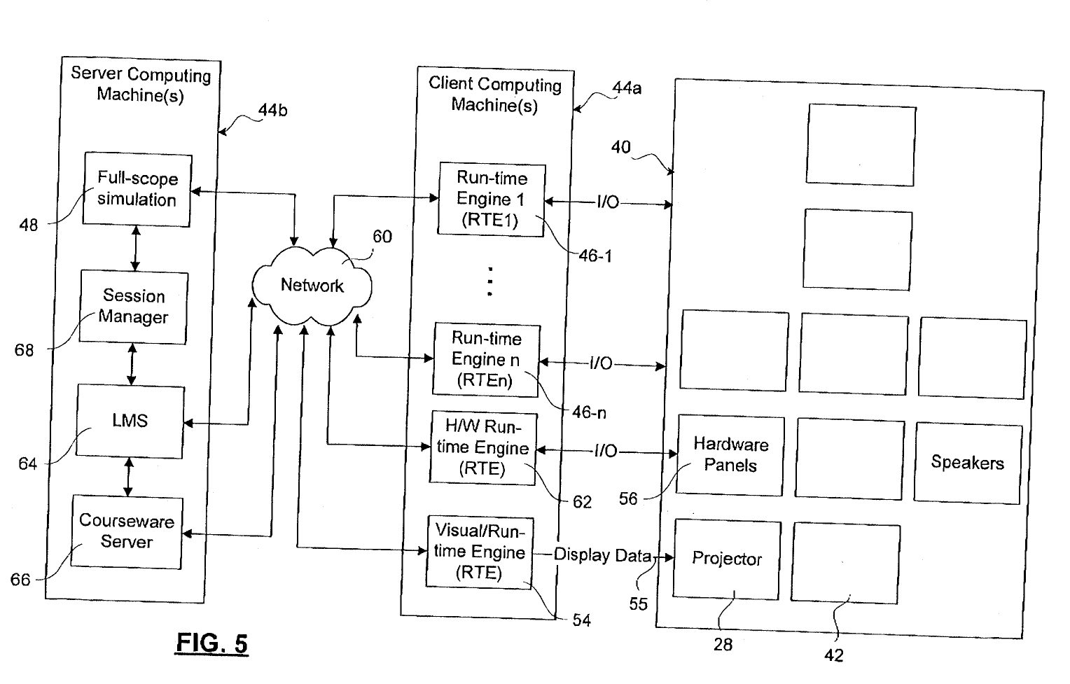

FIG. 5 is a schematic diagram of another embodiment of the integrated procedure training apparatus 40 in accordance with the invention. In this embodiment, client computing machines 44a drive the touch-sensitive display surfaces 42 to display the interactive graphic representations of control panels of a simulated complex system. The full-scope simulation is, however, supported by remote server computing machine(s) 44b. In this embodiment, the simulated complex system is also a cockpit of an aircraft, and therefore has all the features of the embodiment described above with reference to FIG. 4. This architecture is similar to the system described in Applicant's co-pending United States Patent application filed concurrently herewith and entitled System and Method for Distance Learning of Systems Knowledge and Integrated Procedures Using a Real-Time, Full-Scope Simulation, the specification of which is likewise incorporated herein by reference.

The client computing machine(s) 44a and the server computing machine(s) 44b communicate through a network 60. The server computing machine(s) include a session manager 68, which controls access to the full scope simulation as described in the above-referenced co-pending patent application. An optional learning management system (LMS) is used to track and evaluate student training and maintain student records, as well as to launch courseware. A courseware server 66 stores courseware that is adapted to be run by one or more of the RTE(s) 46-1, 46-n. The client computing machine(s) 44a support as many RTE(s) 46-1, 46-n as required to control the respective display surfaces 42 to a satisfactory performance standard and to optionally drive a projector. Each RTE controls the interactive graphical representations displayed by one or more of the touch-sensitive display surfaces 42 and/or projector. As explained in Applicant's above-referenced co-pending application, each RTE 46 subscribes to simulator variables required to dynamically refresh the control panel display(s) for which the RTE 46 is responsible. The client computing machine(s) 44a likewise support a hardware RTE 62 adapted to communicate with the additional hardware 56 to accept user input through the CDU or the autopilot control panel, translate to data into appropriate data elements and transfer the data elements to the full-scope simulation 48 via the network 60.

FIG. 6 is a schematic diagram of another client/server computing machine architecture designed to support an integrated procedures training apparatus 40 in accordance with the invention. This embodiment of the invention is specifically designed for use in instructor-led or free-play mode. The integrated procedures training apparatus 40 is identical to the one described above with reference to FIGS. 4 and 5. The client/server computing machines 44 support one or more RTE (s), as explained above with reference to FIG. 6. The RTE(s) send display data 47 to the respective touch-sensitive display surfaces 42 or projector, and receive student inputs 49 from the touch-sensitive display surfaces 42. The display data is retrieved from the full-scope simulation 48 by the receptive RTE(s), as described above. The RTE(s) 46 pass the student inputs to the full-scope simulation, which changes a state of the simulation and provides display data to update the interactive graphic representations displayed by the touch-sensitive displays 42.

The operator station 32 is used by instructors or students to condition the full-scope simulation for an instructor-led or a free-play learning or practice session. The simulation interface 52, the user interface to the simulation control as described above, provides a level of abstraction that facilitates the conditioning of the full-scope simulation by students and/or instructors who are not familiar with an architecture of operation of the full-scope simulation. After the student has conditioned the full-scope simulation as desired for the practice or training session, the student operates the integrated training apparatus 40 manipulating virtual switches, levers and other simulated control mechanisms displayed on the touch-sensitive display surfaces 42, to control the simulated complex system. In free-play mode all student inputs are passed without filtering directly to the full-scope simulation 48 and the full-scope simulation 48 behaves substantially identically to the real system, had the same inputs been received from the real control panels of the real system. This permits a student or a researcher to use the system in accordance with the invention to practice emergency procedures, try experimental procedures, or develop new procedures for efficiency, disaster recovery or the like, without endangering the student, the public or the simulated equipment.

The invention therefore provides a beneficial training apparatus that permits safe, efficient and economical integrated procedure training, experimentation and development. The apparatus also permits experienced operator and maintenance personal to practice integrated procedures in a supervised (courseware) or unsupervised (free-play) practice mode that permits the experienced personnel to keep current with integrated procedures that the experienced personnel may never have an opportunity to practice in real-life experience.

While the apparatus and systems in accordance with the invention have been depicted and described in several variations, it will be understood by those skilled in the art that other alternate configurations of the apparatus and the system in accordance with the invention can be implemented by a person of skill in the art. The embodiments of the invention described above are therefore intended to be exemplary only. The scope of the invention is therefore intended to be limited solely by the scope of the appended claims.

1. A three-dimensional apparatus for training a student to learn systems and perform integrated procedures required to operate or maintain a complex system, the apparatus comprising:
touch-sensitive display surfaces spatially arranged so that representations of the control panels displayed on the touch-sensitive display surfaces are arranged in a three-dimensional space similarly to real control panels of the complex system; and
a computing machine adapted to accept student input from the touch-sensitive display surfaces, communicate the student input to a full-scope simulation of the complex system, and receive change of condition updates from the full-scope simulation, which are used to dynamically update the representations of the control panels.

2. An apparatus as claimed in claim 1 wherein the computing machine is further adapted to execute courseware that runs in co-operation with the full-scope simulation, and facilitates training of the student to learn systems and perform the integrated procedures.

3. An apparatus as claimed in claim 1 wherein the computing machine is further adapted to communicate through a network with the full-scope simulation, to permit the student to receive integrated procedure training in a location remote from a server that supports the full-scope simulation.

4. An apparatus as claimed in claim 1 wherein the touch-sensitive display surfaces comprise touch screens.

5. An apparatus as claimed in claim 1 wherein the touch-sensitive display surfaces comprise rear projection screens having a display surface that is covered by a touch-sensitive element.

6. An apparatus as claimed in claim 1 further comprising a support structure adapted to support the touch-sensitive display surfaces in the three-dimensional space.

7. An apparatus as claimed in claim 6 wherein the support structure is adapted to be reconfigured and repositioned so that the touch-sensitive display surfaces can be arranged in more than one configuration, and the apparatus can be used for learning systems and training integrated procedures for different complex systems.

8. An apparatus as claimed in claim 6 wherein any supporting member of the support structure can be reconfigured, in order to change relative positions of the touch-sensitive display surfaces, so that the touch-sensitive display surfaces can be rearranged to resemble a spatial configuration of control panels of different complex systems.

9. Apparatus as claimed in claim 2 further comprising courseware server that is adapted to download a courseware course to the client that is processed by a run-time engine (RTE) that runs on the computing machine.

10. An apparatus as claimed in claim 1 further comprising a session manager for providing access to the full-scope simulation by students who attempt to access the full-scope simulation through a network.

11. An apparatus as claimed in claim 1 further comprising a learning management system that is used to track student progress, provide student evaluations, and maintain a comprehensive list of courses the student has completed.

12. Apparatus as claimed in claim 1 further comprising an operator station to setup the full-scope simulation to an operating condition suitable for a practice session.

13. Apparatus as claimed in claim 1 further comprising at least one speaker to permit the courseware to provide a narration of a lesson being presented to the student and reproduce simulated audible warnings generated by the full scope simulation.

14. Apparatus as claimed in claim 1 where in the apparatus further includes a projector for projecting image or other data onto a projection screen in front of the apparatus.

15. Apparatus as claimed in claim 1 further comprising 3-dimensional sub-systems of the complex system to provide tactile feedback during integrated procedure learning and practice.

16. A method for learning systems and practice integrated procedure training to operate or maintain a complex system, comprising steps of:
arranging a plurality of touch-sensitive display surfaces on a 3-dimensional support structure in a spatial arrangement similar to a spatial arrangement of control panels of the complex system, and displaying interactive images of the control panels on the display surfaces;
running a full-scope simulation of the complex system;
passing student inputs representative of manipulations of control instruments sensed by the touch-sensitive display surfaces to the full-scope simulation;
receiving data from the full-scope simulation representing a condition of the full-scope simulation that affects the representations of the control panels on the touch-sensitive display surfaces; and
updating the representations of the control panels, as required, in response to receiving the data.

17. A method as claimed in claim 16 further comprising a step of providing courseware for learning the systems and the integrated procedures in a self-paced or instructor led training mode.

18. A method as claimed in claim 16 further comprising steps of:
providing an operator station adapted to permit an instructor or a student to input simulation control data; and
passing the simulation control data to the full-scope simulation, to condition the simulation.

19. A method as claimed in claim 16 further comprising a step of displaying visual scenes, course text or instructions on a screen located in front of the student to provide the student with a more complete training or practice experience.

20. A method as claimed in claim 16 further comprising a step of supplying additional hardware to enhance the integrated procedure learning, the additional hardware comprising as an example, an autopilot control panel and/or a control display unit.

21. A method as claimed in claim 20 further comprising a step of providing a hardware run-time engine (RTE) adapted to receive student inputs generated by student interaction with the additional hardware, and to filter the respective inputs before passing them to the full-scope simulation.
